(19) United States
(12) Patent Application Publication
(10) Pub. No.: US 2026/0301586 A1
(43) Pub. Date: Oct. 1, 2026

(54) AIRCRAFT AND PILOTING ASSISTANCE METHOD FOR LANDING IN DEGRADED VISIBILITY CONDITIONS

(71) Applicant: AIRBUS HELICOPTERS, Marignane Cedex (FR)

(72) Inventors: Jérémy BLAISE, Aix En Provence (FR); Jean-Pierre BAUDRY, Toulon (FR)

(73) Assignee: AIRBUS HELICOPTERS, Marignane Cedex (FR)

(21) Appl. No.: 19/568,236

(22) Filed: Mar. 16, 2026

(30) Foreign Application Priority Data
Mar. 31, 2025 (FR) FR2503148

(51) Int. Cl. G08G 5/54; G08G 5/21; G08G 5/23; G08G 5/76; G08G 5/80

(52) U.S. Cl. CPC G08G 5/54; G08G 5/21; G08G 5/23; G08G 5/76; G08G 5/80

(57) ABSTRACT

A piloting assistance method for landing an aircraft on a target zone centered on a touchdown point. The method comprises determining a virtual main landing area positioned on the target zone, the virtual main landing area comprising at least four main symbols converging towards the touchdown point, one or two main symbols located in a vertical plane containing a gradient respectively forming one or two alignment symbols, each main symbol not forming an alignment symbol being a radial symbol, the at least one alignment symbol being displayed according to a first graphic charter, each radial symbol being displayed according to a second graphic charter different from the first graphic charter.

### CROSS REFERENCE TO RELATED APPLICATION

This application claims the benefit of FR 25 03148 filed on Mar. 31, 2025, the disclosure of which is incorporated in its entirety by reference herein.

### TECHNICAL FIELD

The present disclosure relates to an aircraft and a piloting assistance method for landing in conditions of degraded visibility, and in particular to an aircraft provided with a rotary wing.

### BACKGROUND

During a landing, the blast produced by the rotation of the rotary wing close to the ground can suddenly lift particles present on the ground. These particles can form a cloud that suddenly blinds the pilot by reducing the visibility of the environment outside the cockpit. In particular, when the aircraft needs to land on a sandy, dusty (dry terrain) or snowy area, a cloud of sand or snow may envelop the aircraft and may obscure a pilot's field of view outside the cockpit. Such a phenomenon is sometimes referred to as “brown-out” in the presence of sand or dust and “white-out” in the presence of snow.

Despite being prepared for it, a pilot is sometimes surprised by the appearance of particles that suddenly and unexpectedly obscure his field of view outside the cockpit. The pilot may then lose his visual references and may engage in an inappropriate maneuver.

Documents WO 2009/081177 and EP 3 217 148 describe a method for facilitating a landing. This method comprises the steps of determining the desired landing point based on the line of sight of a pilot, determining the location of the landing point relative to the aircraft, generating, displaying, and updating symbols on a screen. These symbols comprise a single circle, an “H”-shaped symbol, and a plurality of cones, each cone comprising a base resting on the circle and disks representing various heights. For example, four cones are placed on the circle at the four cardinal points, four other cones are placed between these four afore-mentioned cones.

An excessive number of symbols can saturate a pilot's view on the screen.

Document WO 2005/015333 describes a system comprising sensors receiving information relating to environmental conditions and a processing unit that processes this information in order to assist a pilot.

Document EP 2 116 811 is far from the disclosure wherein it relates to an aircraft guidance system.

Document FR 3 083 779 discloses a piloting assistance method that comprises steps of designating a touchdown point and determining a sighting axis. A single three-dimensional symbol providing a conformal position of the touchdown point is displayed on a screen, said three-dimensional symbol extending in elevation from the ground upwards, from a bottom zone positioned on the ground up to a top zone positioned at a height referred to as the “top height” relative to the ground. At least one two-dimensional symbol covering a target zone is displayed when the aircraft is situated at a distance less than a first threshold distance. This two-dimensional symbol represents a virtual landing area and comprises circles as well as radials.

Document FR 3 134 176 describes the displaying of a representation on a screen, as long as an aircraft is situated at a horizontal distance less than a first threshold from a touchdown point. The representation comprises an aircraft symbol representing said aircraft, a target symbol representing the touchdown point, an displacement symbol representative of the relative displacement of the aircraft with respect to the touchdown point, as well as an elevation symbol illustrating the height of the aircraft relative to the touchdown point, said elevation symbol comprising a mark separated from the target symbol by an elevation distance representative of said height.

Documents EP 4 181 104 A1 and US 2021/0366294 A1 are also known.

### SUMMARY

One object of the present disclosure is therefore to propose an intuitive method for assisting the pilot to visualize and reach an optionally unprepared landing area, in particular in the presence of particles that obscure his vision of the environment outside the cockpit.

The disclosure thus relates to a piloting assistance method for landing an aircraft on a target zone centered on a touchdown point.

The method comprises the following steps:
determining, using an on-board computer, an approach gradient directed towards the target zone;
determining, using the on-board computer, a virtual main landing area positioned, within a representation of the real world, on the target zone, said virtual main landing area optionally comprising, a plurality of closed and nested main lines, the main lines each being centered on the touchdown point and positioned at ground altitude, said virtual main landing area comprising at least four main symbols converging towards said touchdown point, one or two main symbols located in a vertical plane containing said gradient respectively forming one or two alignment symbols, each main symbol not forming an alignment symbol being a radial symbol; and
displaying, on a display, at least one virtual portion of the virtual main landing area, for example as long as said virtual portion is in a field of view of a pilot of the aircraft, said at least one alignment symbol being displayed in accordance with a first graphic charter, each radial symbol being displayed in accordance with a second graphic charter that is different from the first graphic charter.

For example, said main symbols take the form of segments, triangles pointing to the touchdown point, arrows, etc.

In the vicinity of the touchdown area, in the absence of external visual cues, a pilot may lose sight of the approach axis, i.e., the direction of the recommended gradient. The pilot may then be disoriented.

The method makes it possible to remedy this problem by visually distinguishing the alignment symbols disposed along this approach axis. This feature makes it easy to signal the approach axis to a pilot in order to limit the risk of yawing and/or skidding.

The method may further comprise one or more of the following features, taken individually or in combination.

Thus, said displaying may be carried out as long as the aircraft is located at a horizontal distance from said touchdown point less than a transition threshold.

The virtual landing area is then only signaled at the end of the approach so as not to overload the display at the beginning of the approach.

According to one possibility compatible with the preceding possibilities, said at least one alignment symbol may have, according to the first graphic charter, a first thickness, each radial symbol having, according to the second graphic charter, a second thickness different from the first thickness.

This feature makes it possible, for example, to distinguish the alignment symbols from the radial symbols on a monochrome display.

According to one possibility compatible with the preceding possibilities, the first thickness may be greater than the second thickness.

According to one possibility compatible with the preceding possibilities, the first thickness may be equal to three times the second thickness.

According to one possibility compatible with the preceding possibilities, said at least one alignment symbol may have, according to the first graphic charter, a first line style, each radial symbol having, according to the second graphic charter, a second line style different from the first line style.

This feature makes it possible, for example, to distinguish the alignment symbols from the radial symbols on a monochrome display.

Optionally, the first line style and the second line style may be chosen from a list comprising: a continuous line, a broken line, dotted lines.

According to one possibility compatible with the preceding possibilities, said at least one alignment symbol may have, according to the first graphic charter, a first color, each radial symbol having, according to the second graphic charter, a second color different from the first color.

This feature makes it possible, for example, to distinguish the alignment symbols from the radial symbols on a color display.

According to one possibility compatible with the preceding possibilities, the method may comprise determining the wind direction, said gradient being disposed facing the wind.

According to one possibility compatible with the preceding possibilities, the method may comprise determining at least one hazard using at least one terrain database or an obstacle detection system, said gradient being disposed to avoid said hazard.

For example, the on-board computer or a conventional trajectory generator in communication with the on-board computer may establish said gradient.

According to one possibility compatible with the preceding possibilities, said gradient may be directed towards the touchdown point.

This feature makes it possible, for example, to steer the aircraft directly towards the touchdown point.

According to one possibility compatible with the preceding possibilities, said gradient may be directed towards a point located above the touchdown point.

This feature makes it possible, for example, to steer the aircraft directly above the touchdown point, to allow it to simply descend towards the touchdown point during the last phase of the landing. In addition, this feature may facilitate the use of the method described in patent FR 3 134 176.

In addition to a method, the disclosure relates to an aircraft provided with a display and an on-board computer.

The display and said on-board computer are configured to apply the method according to disclosure, said on-board computer being configured to determine said gradient and the virtual main landing area and said display being configured to display said at least one virtual portion.

### BRIEF DESCRIPTION OF THE DRAWINGS

The disclosure and its advantages appear in greater detail from the following description of examples given by way of illustration with reference to the accompanying figures, wherein:

FIG. 1 is a diagram illustrating an aircraft according to the disclosure;

FIG. 2 is a diagram illustrating various symbols that can be displayed on a display according to the disclosure;

FIG. 3 is a diagram illustrating the designation of a touchdown point;

FIG. 4 is a diagram illustrating an approach phase;

FIG. 5 is a diagram illustrating an approach phase;

FIG. 6 is a diagram illustrating an approach phase;

FIG. 7 is a diagram illustrating an example of initiating a hovering phase above the touchdown point;

FIG. 8 is a diagram illustrating an example of initiating a hovering phase above the touchdown point;

FIG. 9 is a diagram illustrating an aircraft approaching the touchdown point;

FIG. 10 is a diagram illustrating the displaying of a virtual complementary landing area when the aircraft reaches the position illustrated in FIG. 9;

FIG. 11 is a diagram illustrating the displaying of complementary lines when the virtual main landing area is no longer in the pilot's field of view;

FIG. 12 is a diagram illustrating the hovering phase in the vicinity of the touchdown point with a displacement symbol bearing a predicted position;

FIG. 13 is a diagram illustrating the variation in speed as a function of the aerodynamic drag coefficient; and

FIG. 14 is a diagram illustrating the variation in angle of incidence as a function of the aerodynamic drag coefficient.

### DETAILED DESCRIPTION

Elements present in more than one of the figures are given the same references in each of them.

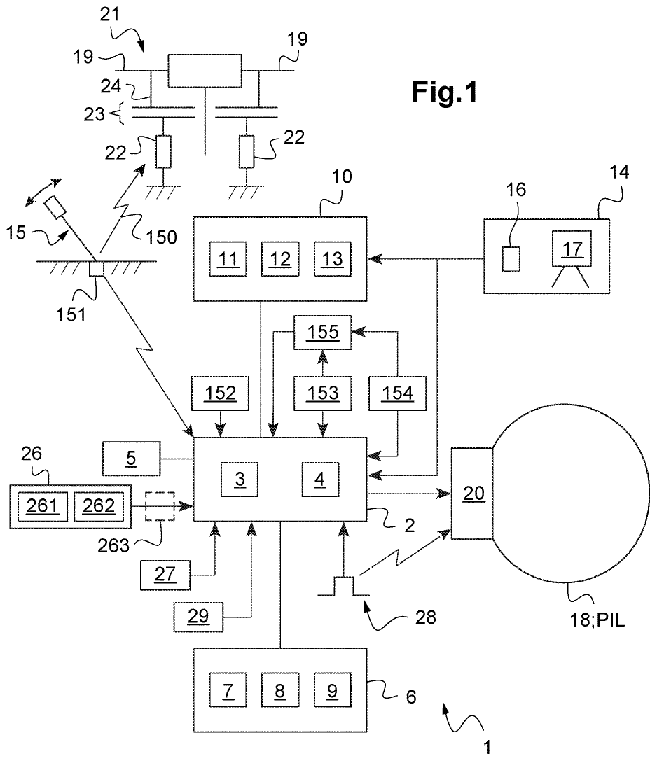

FIG. 1 shows an aircraft 1 according to the disclosure configured to be able to apply the method of the disclosure. This aircraft 1 may, in particular, be an aircraft able to land on an area of reduced surface area. In particular, the aircraft 1 is provided with maneuvering members 22 enabling it to be steered, such as servo-controls or connecting rods or the like, controlling flaps or the pitch of blades, for example. The aircraft 1 may comprise engines or rotors for vertical or substantially vertical landing.

According to the example of FIG. 1, the aircraft 1 may be a helicopter having at least one main rotor 21 provided with blades 19.

The pitch of the blades 19 is controlled, for example, by conventional interfaces. The term “interface” means a device that can be operated by a pilot. For example, the aircraft 1 comprises a collective pitch human-machine interface 15, such as a conventional collective pitch lever. Such a collective pitch human-machine interface 15 then controls, according to the example illustrated, actuators forming the maneuvering members 22, via a mechanical or electrical system 150, the actuators being able to move a swashplate device 23 connected by at least one pitch rod 24 to each blade 19.

Independently of the nature of the aircraft 1 and of these maneuvering members 22, the aircraft 1 comprises an on-board computer 2. The on-board computer 2 may comprise one or more computers, one or more electronic boards, etc. The on-board computer 2 may comprise, for example, at least one processor 3 and at least one memory 4, at least one integrated circuit, at least one programmable system, at least one logic circuit, these examples not limiting the scope given to the expression “on-board computer”.

The on-board computer 2 can communicate with a position sensor 6 via a wired or wireless link. Such a position sensor 6 transmits, to the on-board computer 2, information relating to the position of the aircraft 1 in space, for example with respect to a terrestrial reference frame and/or a touchdown area. For example, such a position sensor 6 may comprise a satellite positioning system 7 and/or a radiosonde 8 and/or a radar 9 or equivalent, and/or an optical system and/or an inertial unit, etc.

The on-board computer 2 may communicate with a speed sensor 5 via a wired or wireless link, in order to obtain information relating to a forward speed of the aircraft 1, or even to determine the velocity vector 105 of the aircraft 1. Such a speed sensor 5 may comprise a satellite positioning system, an anemometric sensing element, an inertial unit, etc.

Furthermore, the on-board computer 2 may communicate, via a wired or wireless link, with a designator 10 capable of designating a touchdown point. In general, the designator 10 may comprise any member making it possible to parameterize the coordinates of a touchdown point, for example in the terrestrial reference system.

Such a designator 10 may comprise, for example, an on-board member 11 that can be operated by a pilot, such as a button or equivalent, enabling a pilot to designate a touchdown point by passing over this touchdown point or to designate the touchdown point on a mapping tool via a human-machine interface as a tactile, visual, gestural or other means. The designator 10 may comprise an on-board character entry member 12 that can be operated by a pilot, such as a keyboard or a mouse, for example, for digital entry of the coordinates of the touchdown point. The designator 10 may comprise a data receiver 13 for receiving the coordinates of the touchdown point transmitted by a third party with a remote transmitter, for example a third party present on the ground or in another aircraft 1. According to other examples, the designator 10 may comprise a laser system, a system tracking the line of sight of a pilot of the type known by the expression “Eye Tracker”, etc.

Furthermore, the aircraft 1 may carry a conventional posture detector 14 determining the field of view of a pilot. For example, the posture detector 14 may comprise at least one camera 17 and an imaging computer 16. This posture detector 14 can serve, in particular, as a designator and can transmit information relating to the field of view of the pilot to the on-board computer 2. According to this variant, the on-board computer 2 determines the pilot's field of view from a posture transmitted by the imaging computer 16, or the posture detector 14 transmits the coordinates of the line of sight to the on-board computer 2. For example, the field of view may be defined by an ellipse constructed from the vertical field of view and the horizontal field of view centered on a line of sight followed by the pilot's gaze. A reduced field of view can also be calculated in order to display some symbols before other symbols disappear. Conventional methods can be used to determine the field of view of the pilot.

Furthermore, the aircraft 1 comprises at least one display 20 displaying a symbology of a particular technical nature to enable landing on a target zone. The on-board computer 2 is configured to determine this symbology, and to transmit signals to the display 20 for the displaying of this symbology. For example, the on-board computer 2 comprises a computer determining the values of the parameters used and a symbol generator computer, or the same computer fulfilling these two functions.

Such a display 20 may, for example, be a screen of a head-down instrument, a head-up display, for example of the screen of a helmet 18 type worn by a pilot PIL, a retinal projection means, a windscreen projection means, or a head-up display or the like. The display 20 may be transparent for displaying technical data superimposed on the real world or for displaying an image representing this real world.

Furthermore, the on-board computer 2 may communicate via a wired or wireless link with a density sensor 26 measuring a density rho of ambient air outside the aircraft 1, the density sensor 26 communicating directly or indirectly via a conventional avionics system with the on-board computer 2. Such a density sensor may comprise a sensing element 261 measuring the outside temperature and a sensing element 262 measuring the outside pressure, the on-board computer or an avionics computer determining the density in the usual manner as a function of the outside pressure and outside temperature.

Furthermore, the on-board computer 2 and/or the display 20 may communicate with an inclination sensor 27 via a wired or wireless link, in order to measure a current angle, the inclination sensor 27 communicating directly or indirectly with the on-board computer 2 or the display 20. For example, the inclination sensor 27 may comprise an inclinometer or an inertial unit measuring a pitch attitude angle.

Furthermore, the on-board computer 2 may communicate via a wired or wireless link, directly or via an avionics system of the aircraft 1, with a wind sensor 29 making it possible to estimate the direction of the wind. For example, the wind sensor 29 may comprise an anemobarometric sensor or a link with a meteorological station.

Furthermore, the on-board computer 2 can communicate via a wired or wireless link, directly or via an avionics system of the aircraft 1, with a height sensor 152. Such a height sensor 152 may, for example, be in the form of a radiosonde.

Furthermore, the on-board computer 2 can communicate via a wired or wireless link, directly or via an avionics system of the aircraft 1, with a terrain database 153.

Furthermore, the on-board computer 2 may communicate via a wired or wireless link, directly or via an avionics system of the aircraft 1, with an obstacle detection system 154 of the aircraft 1. Such a system may, for example, comprise a RADAR (i.e., “radio detection and ranging”) or LIDAR (i.e., “light detection and ranging”) system.

Furthermore, said aircraft 1 may comprise an activation human-machine interface 28 communicating via a wired or wireless link, directly or indirectly, with the on-board computer 2 or the display 20.

Furthermore, said aircraft 1 may comprise a collective pitch sensor 151 transmitting, directly or indirectly, to the on-board computer 2 or to the display 20, a signal bearing a collective pitch component of the blades 19. According to the example given, the collective pitch sensor 151 may take the form of a position sensor measuring a position of the collective pitch human-machine interface 15. According to another example, a flight control may generate a signal transmitted to a conventional piloting system, this piloting system forming such a collective pitch sensor capable of transmitting the required collective pitch component to the on-board computer 2.

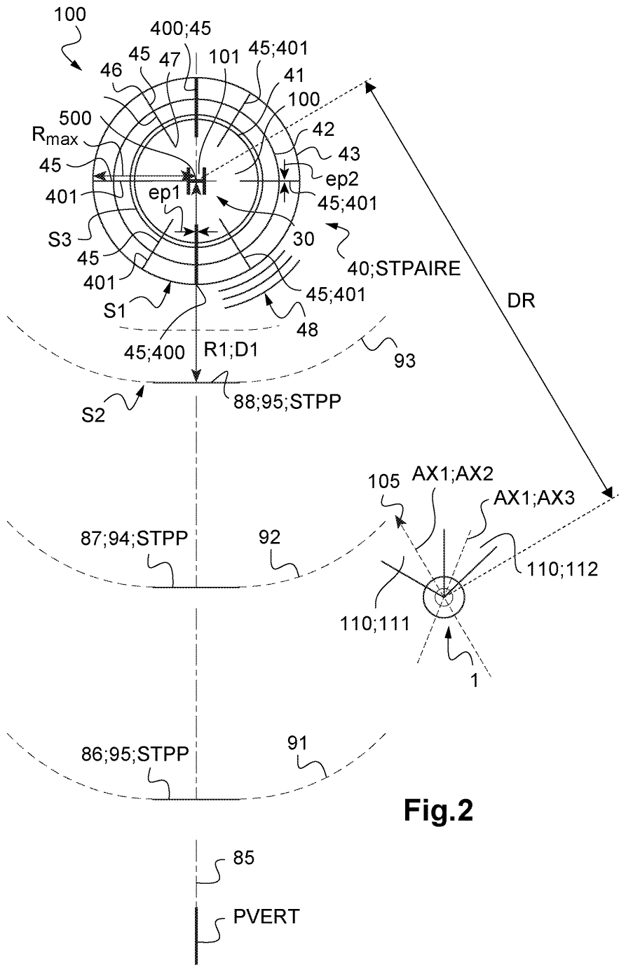

With reference to FIG. 2, the on-board computer 2 is configured to determine the positions, or even the shapes, of various symbols in space, permanently or as a function of a horizontal distance DR separating the aircraft 1 from the touchdown point 101, i.e., a distance separating a projection of the aircraft 1 in a horizontal plane containing the touchdown point 101. For example, the on-board computer 2 may determine the positions of symbols illustrating a virtual main landing area 40 positioned, within a representation of the real world, on a target zone 100 to be reached during a step STPAIRE, and/or passing gates 86, 87, 88.

The virtual main landing area 40 may comprise at least two, or even three, main lines 41, 42, 43 that are closed and nested one inside the other. Each main line 41, 42, 43 may form a circle and the circles may be concentric. In another example, each main line 41, 42, 43 may form a polygon.

In addition, each main line 41, 42, 43 may be centered on the touchdown point 101 and positioned at ground altitude. Therefore, each main line 41, 42, 43 forms a two-dimensional pattern. The virtual main landing area 40 is positioned on the target zone 100 and contained in a circle, this circle having a maximum radius Rmax and being centered on the touchdown point 101.

Furthermore, the virtual main landing area 40 comprises at least four main symbols 45 oriented radially with respect to the touchdown point 101. For example, said main symbols 45 take the form of segments, triangles pointing to the touchdown point, arrows, etc. By way of illustration, the figures show main symbols of the “segment” type.

Optionally, the main symbols 45 and the main lines 41, 42, 43 are present in the same plane. In addition, each main symbol 45 may extend from a first end 46 to a second end 47. The first end 46 is optionally positioned on the only main line 43 that is not surrounded by another main line 41, 42. The second end 47 may optionally not reach the touchdown point 101.

According to one embodiment illustrated below, the main lines 41, 42, 43 form concentric circles, the main symbols 45 extending radially towards the touchdown point 101.

Furthermore, the virtual main landing area 40 may comprise a central shape 500, for example an H-shape, an X-shape, etc. This central shape 500 is positioned on the touchdown point 101 and optionally between the second ends 47 of the main symbols 45. The virtual main landing area 40 can be completed under conditions mentioned subsequently by a virtual complementary landing area arranged in its center, the central shape 500 being able to be displaced. In addition, lines 48 can form a trace leading to the virtual main landing area 40.

Depending on the position of the aircraft 1 or the inclination of the pilot's head for example, the various symbols may be displayed in whole or in part on the display 20 superimposed on the real world in the case of a transparent screen or optionally superimposed on an illustration of the real world constructed using the terrain database 153.

Furthermore, the on-board computer 2 may optionally calculate the coordinates of passing gates 86, 87, 88 embodying a possible gradient 85 to reach the touchdown point 101. The on-board computer 2 may optionally calculate the coordinates of at least two passing gates 86, 87, 88, for example at least two or three passing gates referred to more simply as “gates”. Optionally, the passing gates 86, 87, 88 may be parallel to one another. Each passing gate 86, 87, 88 may be tangential to a cylinder centered on the touchdown point 101 or inclined with respect to this cylinder so as to be orthogonal to the gradient 85 in order to nest naturally during the descent. In this case, the gate can be inclined by being rotated around an intersection between the gradient and the cylinder. Each cylinder may be rotationally symmetric and have a radius equal to a predetermined distance D1 multiplied by an integer. For example, the first passing gate 86 is tangential to a first cylinder 91 having a radius equal to three times the predetermined distance D1, the second passing gate 87 is tangential to a second cylinder 92 having a radius equal to twice the predetermined distance D1, and a third passing gate 88 is tangential to a third cylinder 93 having a radius R1 possibly equal to the predetermined distance D1. The third passing gate 88 represents the gate closest to the touchdown point 101.

In addition, one passing gate, and in this case the second passing gate 87 according to FIG. 2, may be an active gate 94, the other gates 86, 88 being inactive gates 95. The active gate 94 is the gate situated along the cylinder that is between the aircraft 1 and the touchdown point 101 and closest to the aircraft 1. The active gate 94 may have a visual representation, within the representation of the real world, different from the inactive gates 95. For example, the active gate 94 is drawn with lines that are thicker and/or of a color other than that of the lines representing the inactive gates 95.

Furthermore, the main symbols 45 comprise one or two alignment symbols 400 situated in a vertical plane PVERT containing said gradient 85, each main symbol 45 not forming an alignment symbol 400 being a radial symbol 401. For example, two alignment symbols 400 may surround the central shape 500.

The one or more alignment symbols 400 are displayed according to a first graphic charter. The radial symbols 401, on the other hand, are displayed according to a second graphic charter different from the first graphic charter. The central shape 500 may be displayed according to a dedicated graphic charter or may be identical to the alignment symbols, for example. The expression “graphic charter” means the way wherein the associated symbol is visually represented. This feature enables a pilot to locate the approach axis in the event of drift, by easily identifying the one or more alignment symbols 400.

According to one example, the one or more alignment symbols 400 have a first thickness ep1 different from a second thickness ep2 of the radial symbols 401. For example, the first thickness ep1 is greater than the second thickness ep2, or is equal to three times the second thickness ep2. This feature may be advantageous, in particular, in the presence of a monochrome display.

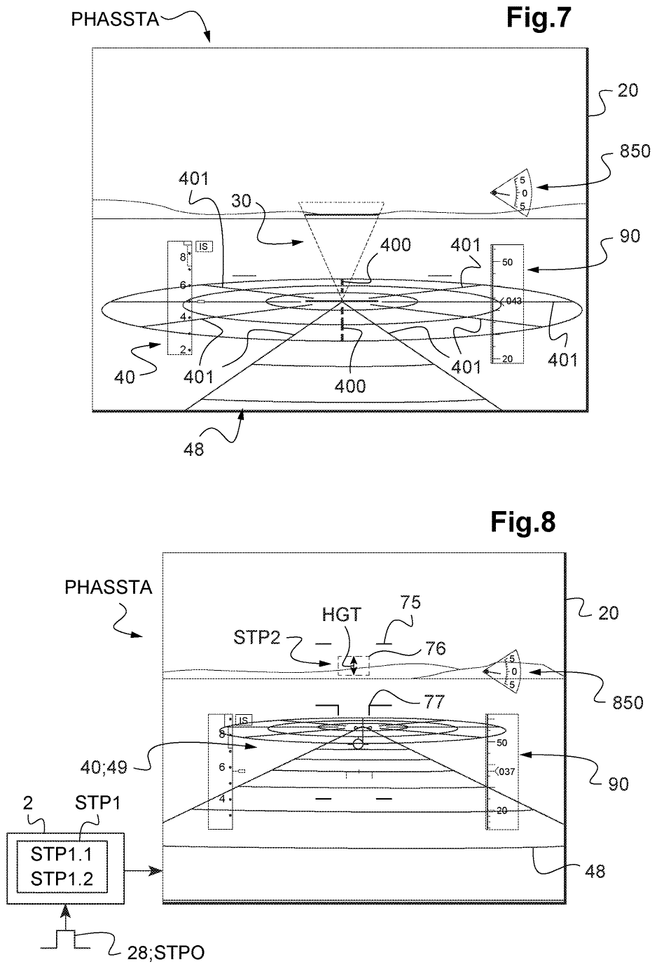

According to a complementary or alternative possibility illustrated in FIG. 7 described below, the two alignment symbols 400 and the radial symbols 401 are represented using different line styles. For example, the main symbols 400 are represented using a first line style and the radial symbols 401 are represented using a second line style. Optionally, the first line style and the second line style are chosen from a list comprising: a continuous line, a broken line, dotted lines. This feature may be advantageous, in particular, in the presence of a monochrome display.

According to a complementary or alternative possibility, the two alignment symbols 400 have a different color from a color of the radial symbols 401.

According to another aspect and with reference to FIG. 2, the on-board computer 2 can determine the field of view 110, and possibly also a sighting axis AX1 and a field of view 110 aligned with the sighting axis AX1. The on-board computer 2 then transmits a signal to the display 20 in order to display the possible part of the above-mentioned symbols situated at a location in the real world, corresponding to a location present in the field of view 110 by giving them the shape viewed along the sighting axis AX1.

According to a variant, the sighting axis AX1 may be coincident with a displacement axis AX2 aligned according to the velocity vector 105 of the aircraft 1, determined using the speed sensor 5. Only the elements present in this field of view 110 are then displayed. In particular, the first gate 86 and the second gate 87 are not displayed according to the example of FIG. 2.

According to another variant, the sighting axis AX1 may be coincident with the line of sight AX3 of the pilot, the field of view 110 then corresponding to the real field of view 112 of the pilot. According to the example of FIG. 2, no part of the virtual main landing area 40 and no gates 86, 87, 88 are then displayed.

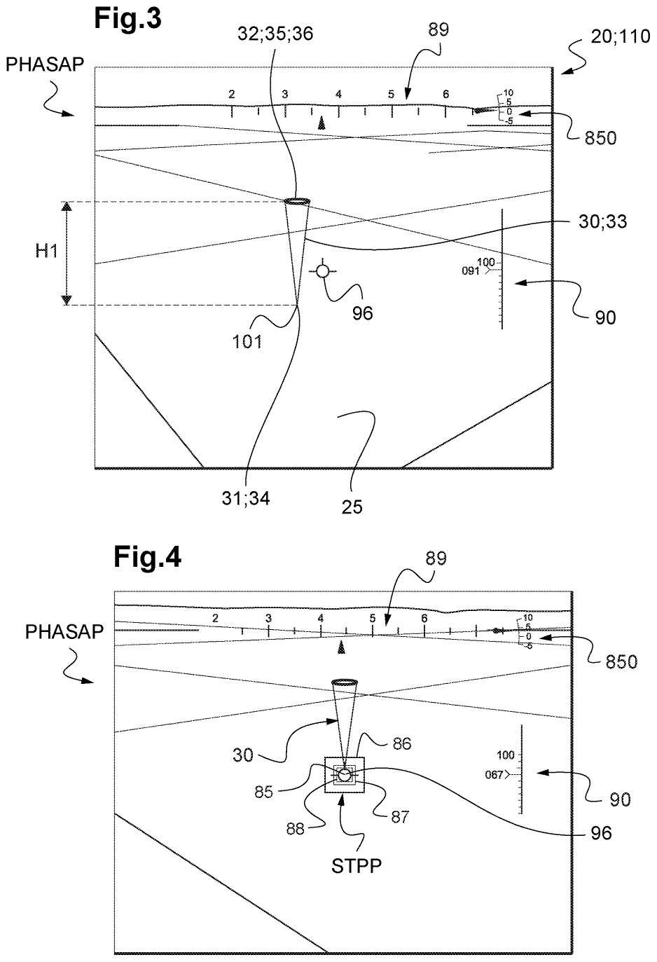

FIGS. 3 to 14 illustrate the method according to the disclosure.

With reference to FIG. 3, the method may comprise an optional approach phase PHASAP. This approach phase PHASAP may comprise a step of designating the touchdown point 101 using the designator 10. The touchdown point 101 can be set by the pilot or transmitted to the aircraft 1 from outside the aircraft 1.

The on-board computer 2 estimates the field of view 110 and can display on the display 20, possibly superimposed on the real world or an illustration of the real world, each part of a conformal designation symbol 30 contained in the field of view 110. As soon as said touchdown point 101 is validated, a dedicated symbology then appears on the display 20 at the validated position to show where the touchdown point 101 is located and optionally to provide an indication of height and roll of the aircraft 1.

For this purpose, the designation symbol 30 may extend in elevation from the ground 25 upwards, starting from a bottom zone 31 resting on the ground 25 up to a top zone 32 positioned at a top height H1 with respect to the ground 25. The bottom zone 31 may be reduced to a point positioned at the touchdown point 101.

The surface area of the top zone 32 may be calculated by the on-board computer 2 as a function of the accuracy of the satellite positioning system 7, for example. The top zone 32 may be positioned at a top height H1 from the ground 25. For example, this top height H1 may be fixed along the approach and equal to a predetermined height or to a height of the aircraft 1 evaluated using the height sensor 152 at the time of designating the touchdown point 101.

For example, the designation symbol 30 is a cone 33 conveniently referred to as an “inverted” cone. This cone 33 then extends upwards from an apex 34 of the cone 33 forming the lower zone 31 up to a base 35 forming the top zone 32.

The designation symbol 30, represented in two or three dimensions, may be displayed according to a reference graphic charter. This reference graphic charter may consist of using only fine continuous lines.

Furthermore, at each instant, the designation symbol 30 may comprise a height line 36 that moves as a function of the height of the aircraft 1. When the designation symbol 30 is in the shape of a cone with a circular base, the height line 36 may be in the shape of a circle or a bar and corresponds to an intersection between the cone 33 and a plane parallel to the base.

This height line 36 may be displayed according to a complementary graphic charter different from the reference graphic charter. This complementary graphic charter may consist, for example, in using only thick continuous lines to clearly distinguish the height line 36 from the other lines of the designation symbol 30.

Furthermore, the on-board computer 2 can position the height line 36 between the lower zone 31 and the top zone 32 and at the current height of the aircraft 1, as long as the current height of the aircraft 1 is less than the top height H1. On the other hand, and in accordance with the representation of FIG. 3, the height line 36 is positioned at the level of the top zone 32 of the designation symbol 30, as long as the height of the aircraft 1 is greater than or equal to the top height H1.

Optionally, the height line 36 may appear only when the horizontal distance separating the aircraft 1 from the touchdown point 101 is less than or equal to a predetermined distance threshold.

According to one possibility, the value of the horizontal distance DR may be inscribed close to, and possibly also above, the designation symbol 30.

Therefore, whatever the visibility conditions, the designation symbol 30 provides not only the compliant position of the touchdown point 101 to be reached, but also height information of the aircraft 1 relative to the terrain, and possibly also attitude information of the aircraft 1 relative to the terrain as illustrated below.

Furthermore, the on-board computer 2 can determine the orientation of the velocity vector 105 of the aircraft 1 by conventional methods. During a display step, the on-board computer 2 can control the display 20 to display a symbol 96 representing this velocity vector 105, at least as long as the aircraft 1 has an air speed greater than a predetermined threshold. At low speed, i.e., below the predetermined threshold, the calculation of the air speed may be relatively inaccurate. Consequently, below a forward speed threshold the symbol 96 need not be displayed, so as to limit the information displayed in order to facilitate the analysis work of the pilot.

Furthermore, the display 20 can be controlled to display the usual data, such as a heading 89, a radio altitude scale 90, a variometer 850, etc.

With reference to FIG. 4, the method may comprise determining, during a step STPP and with the on-board computer 2, at least two passing gates 88, 86, 87 each centered on a gradient 85 and each embodying a gate through which the aircraft 1 can pass to reach the touchdown point by following said gradient 85.

By requesting, for example, manual or voice control or even a tactile or other control, the on-board computer 2 may calculate a gradient of a trajectory conveniently referred to as a “joining” trajectory, in order to reach the target zone 100.

According to one possibility, the method comprises determining the direction of the wind using the wind sensor 29, the gradient 85 then being positioned automatically by the on-board computer 2 so as to face into the wind. According to another possibility, the gradient 85 is determined from the current position of the aircraft 1, or according to a heading set using an interface (not illustrated), or according to a heading established by a computer 155 of the avionics system and, for example, a trajectory generator to avoid possible obstacles known from the on-board terrain database 153, or detected by an active obstacle detection system 154, or received by data link and/or to avoid a hazardous area. The aircraft 1 may optionally comprise an interface for selecting the desired option from a list comprising several of the above possibilities.

The gradient 85 may be directed towards the touchdown point 101. Alternatively, the gradient 85 may be directed towards a point situated above this touchdown point 101, i.e., vertically above the touchdown point, for example at a predetermined or set or even calculated fixed height. The aircraft 1 may optionally comprise an interface for selecting the desired option from a list comprising several of the above possibilities.

The pilot can repeat this step several times, a new joining trajectory being calculated at each iteration. Optionally, the pilot is not required to follow this joining trajectory, the joining trajectory being illustrated for information purposes only, in order to help the pilot if necessary.

The on-board computer 2 may then calculate the gradient 85 illustrating a recommended trajectory, using a stored gradient, or may use a gradient angle set by the pilot.

The on-board computer 2 may then calculate the position of at least two passing gates 86, 87, 88, and in particular three passing gates according to this example. These passing gates 86, 87, 88 are, for example, given by way of indication. Therefore, the system does not generate an alarm if one or more passing gates 86, 87, 88 have not been passed through.

Each passing gate 86, 87, 88 may be positioned as a function of a stored distance horizontally separating the passing gate 86, 87, 88 and the touchdown point 101, and may be centered on the calculated gradient 85, for example. The on-board computer 2 can then transmit a signal to the display 20 to display each section of the passing gates 86, 87, 88 situated at a location present in the field of view 110.

In the case of a nominal approach phase following the calculated trajectory illustrated in FIG. 4, the three passing gates 86, 87, 88 are nested one inside another.

To easily follow this trajectory, if desired, the pilot need only fly the aircraft 1 so that the symbol 96 is positioned in the active gate.

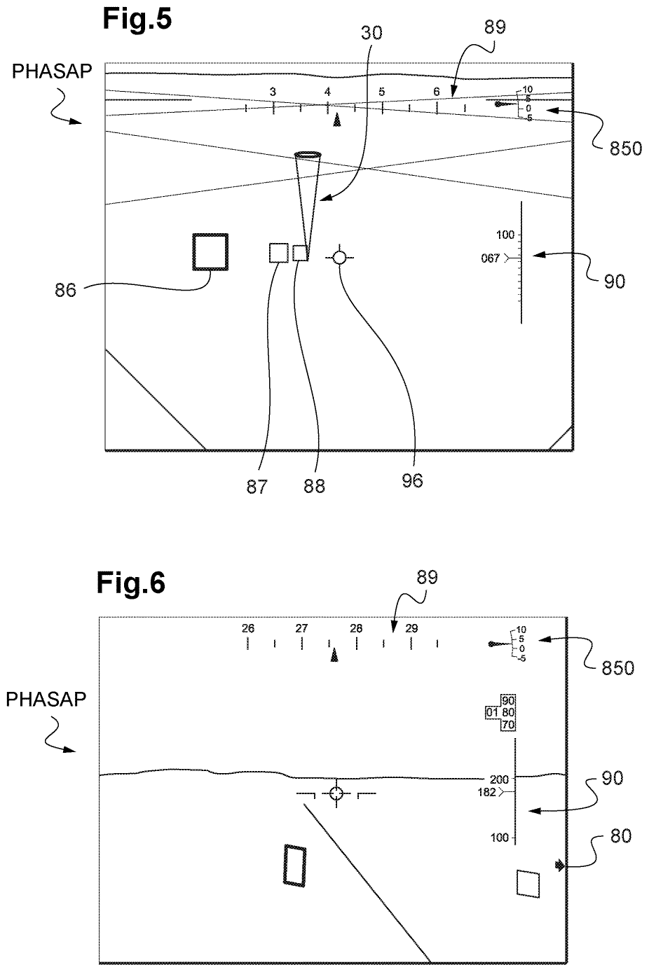

With reference to FIG. 5, the shape of the various symbols displayed, and in particular of the passing gates 86, 87, 88, is recalculated by the on-board computer 2 as a function of the relative positioning of the sighting axis AX1 and these symbols.

By way of example and in the presence of an aircraft 1 having a main rotor 21, the size of these passing gates 86, 87, 88 may be a function of the diameter of the rotor disk of the main rotor 21. These passing gates 86, 87, 88 may be either of fixed and identical sizes, or of decreasing sizes.

With reference to FIG. 6, if the touchdown point 101 is no longer in the field of view 110, the on-board computer 2 can calculate a direction wherein the touchdown point 101 is located and can transmit a signal to the display 20 to display an arrow 80 directed towards the touchdown point 101.

With reference to FIG. 7, at least when the aircraft 1 is situated at a horizontal distance DR less than a transition threshold conveniently referred to as the “second threshold S2”, a final phase PHASSTA may begin. During a step STPAIRE, the on-board computer 2 can determine the position and shape of the virtual main landing area 40 and transmits a signal to the display 20 so as to display, on the display 20, each virtual portion 49 of the virtual main landing area 40 situated at a location present in the field of view 110.

By way of example, the second threshold S2 may be a stored fixed distance, for example of order 200 meters. According to another example, the second threshold S2 may be variable, for example as a function of the ground or air speed of the aircraft 1 and/or of an estimated flight time to reach the touchdown point 101. Optionally, the gate 88 closest to the touchdown point 101 is situated at a distance from the touchdown point 101 equal to the second threshold S2.

Optionally, the virtual main landing area 40 appears gradually, in the form of a fade.

According to FIG. 7, the designation symbol 30 may be retained. In addition, FIG. 7 illustrates the fact that the height line 36 moves within the designation symbol 30 as it approaches the touchdown point 101 as the aircraft 1 approaches the ground. One or more alignment symbols 400 are also placed in the vertical plane PVERT containing the gradient 85, and are displayed in such a way as to be visually distinguished from the radial symbols 401. Moreover, the orientation of the central H-shape 500 also provides the pilot with the orientation of the arrival axis predetermined by the on-board computer 2. In FIG. 7, the current axis is correct.

According to FIG. 8, the designation symbol 30 may optionally disappear on command from the on-board computer 2.

Irrespective of this aspect, the pilot may reduce the speed of displacement of the aircraft 1 close to the ground. The symbol 96 may then disappear. Piloting, very close to the touchdown point 101, can be performed using only the displayed symbols, artificially plotted optionally superimposed on the real world or a representation of the real world, these symbols moving and being modified according to the relative position of the aircraft 1 relative to the touchdown point 101.

Independently of this aspect, the piloting assistance method may comprise an assistance phase illustrated in FIG. 8.

Optionally, the method comprises activating this assistance phase, during a prior step STP0 of the assistance phase, by a pilot operating the human-machine activation interface 28. According to this variant, the assistance phase is implemented only as long as the assistance phase is activated. If the pilot operates the activation human-machine interface 28 or a dedicated interface again, the assistance phase is interrupted.

Independently of this possibility, the assistance phase comprises determining, during a step STP1 and using the on-board computer 2, a recommended angle theta configured to assist a pilot in converging towards a predetermined target speed vp with the aircraft.

This recommended angle theta may be a pitch attitude angle. In addition, the on-board computer 2 determines this angle theta by means of a calculation law taking into account the target speed vp and the estimated current aerodynamic drag fx.

For example, when the aircraft 1 is a helicopter comprising a main rotor 21 provided with blades 19 contributing to the lift of this aircraft 1, the method may comprise determining STP1.1 the current aerodynamic drag fx estimated as a function of a collective pitch component of a pitch angle of the blades 19.

For example, this determination step STP1.1 comprises determining, using the on-board computer 2, a collective pitch command generated by the collective pitch human-machine interface 15. Optionally, the on-board computer 2 evaluates this command by decoding an analog or digital signal emitted by the collective pitch sensor 151.

The on-board computer 2 then evaluates the current aerodynamic drag fx estimated as a function of the pitch command and a parameterization law.

Therefore, the calculation law may comprise a main law applied by the on-board computer 2 giving an aerodynamic drag coefficient cx.

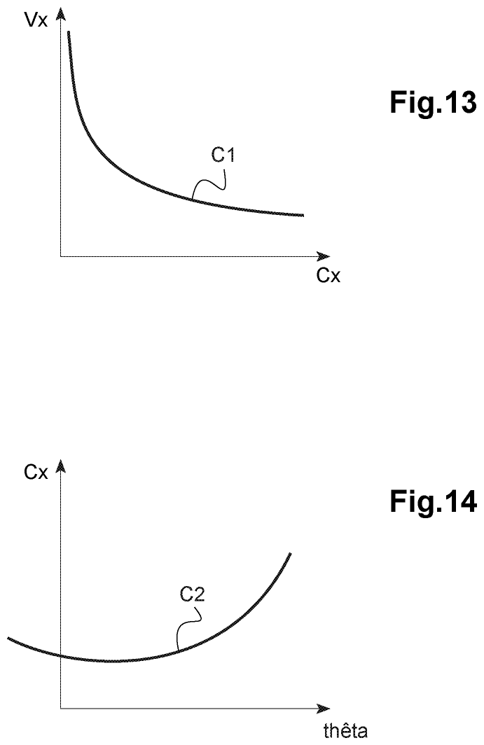

FIG. 13 shows a diagram comprising a curve C1 giving the desired speed as a function of the aerodynamic drag coefficient cx for a given aerodynamic drag.

For example, said main law is:

$$c x = ( 2 * fx ) / ( vp * vp * rho * S )$$

where “cx” represents said drag coefficient, “vp” represents the target speed, “rho” represents the density evaluated using the density sensor 26, “S” represents a predetermined surface area, “fx” represents the estimated current aerodynamic drag, “=” is the equals sign, “*” is the multiplication sign and “/” is the division sign.

Then, the calculation law comprises a secondary law. The secondary law comprises an equation or table of values for example, illustrating the curve C2 shown in FIG. 14, and applied by the on-board computer 2, this secondary law giving the aerodynamic drag coefficient cx calculated previously as a function of an angle of incidence of the aircraft 1. Depending on the variant, the recommended angle is then equal, according to a tertiary law, to the angle of incidence of the aircraft 1, or is equal to the angle of incidence plus a predetermined reference angle.

Independently of this aspect, the assistance phase comprises displaying, during a step STP2 and on the display 20, with respect to an angle-graduated scale 75, a first assistance symbol 76 bearing the recommended angle theta, i.e., positioned on the scale to point to the recommended angle theta, and a second assistance symbol 77 bearing a current angle angcur, i.e., positioned on the scale to point to the current angle angcur. This current angle angcur can be evaluated using the inclination sensor 27.

The shape of the first assistance symbol 76 may be predetermined. Alternatively, the method may comprise calculating, during a step STP1.2 and using the on-board computer 2, a dimension, and for example the height HGT, of the first assistance symbol 76 as a function of a calculation accuracy. For example, the on-board computer 2 applies a stored dimensioning law giving said accuracy as a function of the wind speed measured by the wind sensor 29.

Optionally, this displaying STP2 is carried out as long as the aircraft 1 is situated at a horizontal distance DR from said touchdown point 101 between a maximum distance limit LDMAX and a minimum distance limit LDMIN.

According to a variant, said minimum distance limit LDMIN is equal to 0 meters. According to another variant, said minimum distance limit LDMIN is equal to the maximum radius Rmax. Optionally, a pilot can choose the desired variant using an interface of the aircraft 1.

Optionally, said maximum distance limit LDMAX is equal to the radius R1 of the cylinder 93 associated with the passing gate 88 that is closest to the touchdown point 101.

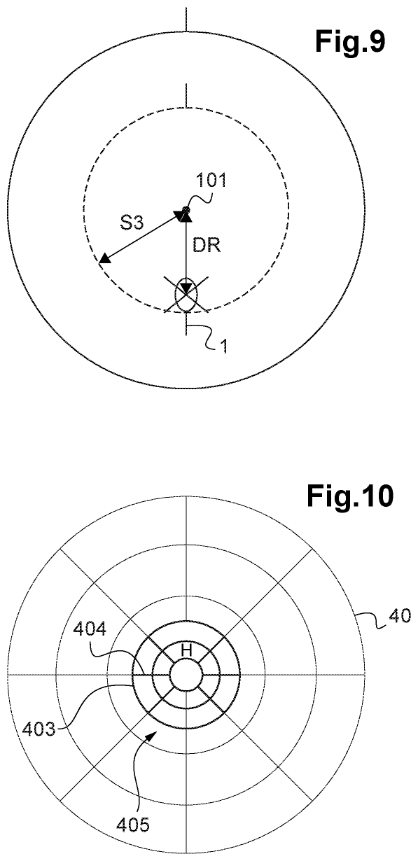

Furthermore and with reference to FIG. 9, when the horizontal distance DR is less than a threshold conveniently referred to as the “third threshold S3”, the on-board computer 2 can calculate and request the display of a complementary shape 405. The third threshold S3 is less than the second threshold S2. At this stage, the aircraft 1 may be located above the zone covered by the virtual main landing area 40.

With reference to FIG. 10, this complementary shape 405 may be a virtual complementary landing area 400 arranged in the center of the virtual main landing area 40. Like the virtual main landing area 40, the virtual complementary landing area 400 may comprise lines 403 and radials 404. The H-shape can be retained, but displaced.

With reference to FIG. 11, when the virtual main landing area 40 no longer appears in the field of view 110 and at least when the aircraft 1 is situated at a horizontal distance less than the second threshold S2 from the touchdown point 101, the on-board computer 2 can calculate the shape and location of a secondary symbol 71, 72, 73, 74 and transmits a signal to the display 20 to display this secondary symbol 71, 72, 73, 74 in the field of view 110. The secondary symbol 71, 72, 73, 74 may only appear when the virtual main landing area 40 has disappeared or when the virtual main landing area 40 no longer appears in the optional reduced field of view.

To assist the pilot in knowing where the aircraft 1 is in the presence of degraded visibility, the on-board computer 2 calculates the location of at least three secondary symbols 71, 72, 73 in the form of closed lines centered on the touchdown point 101 and at least one secondary symbol 74 in the form of a radial secondary symbol, and transmits a signal to the display 20 to display each part of the secondary lines 71, 72, 73 and of the radial secondary symbol or symbols 74 visible in the field of view 110.

The secondary lines 71, 72, 73 and the radial secondary symbols 74 may be displayed according to an additional graphic charter in order to have a graphical representation visually different from a graphical representation of the main lines 41, 42, 43 and the main symbols 45 respectively.

The secondary lines 71, 72, 73 are positioned, for example, at ground altitude around the main lines 41, 42, 43 and at predetermined distances from the touchdown point 101. Each radial secondary symbol 74 converges towards the touchdown point 101.

Furthermore, the method may comprise an assistance phase for hovering in the vicinity of the touchdown point 101.

Thus, when the on-board computer 2 detects that the horizontal distance DR is less than a first threshold S1, the on-board computer 2 determines and requires the displaying of a two-dimensional representation 50 of said aircraft 1 relative to the touchdown point 101 viewed from above or below. The first threshold S1 is less than the second threshold S2 and greater than the third threshold S3.

By way of example, the first threshold S1 may be a stored fixed distance, and be, for example, equal to 60 meters and/or to a radius Rmax of the largest circle of the virtual main landing area 40. According to another example, the first threshold S1 may be variable, for example as a function of the ground or air speed of the aircraft 1 and/or of an estimated flight time to reach the touchdown point 101.

Optionally, the first assistance symbol and the second assistance symbol are still displayed or are no longer displayed depending on the variant.

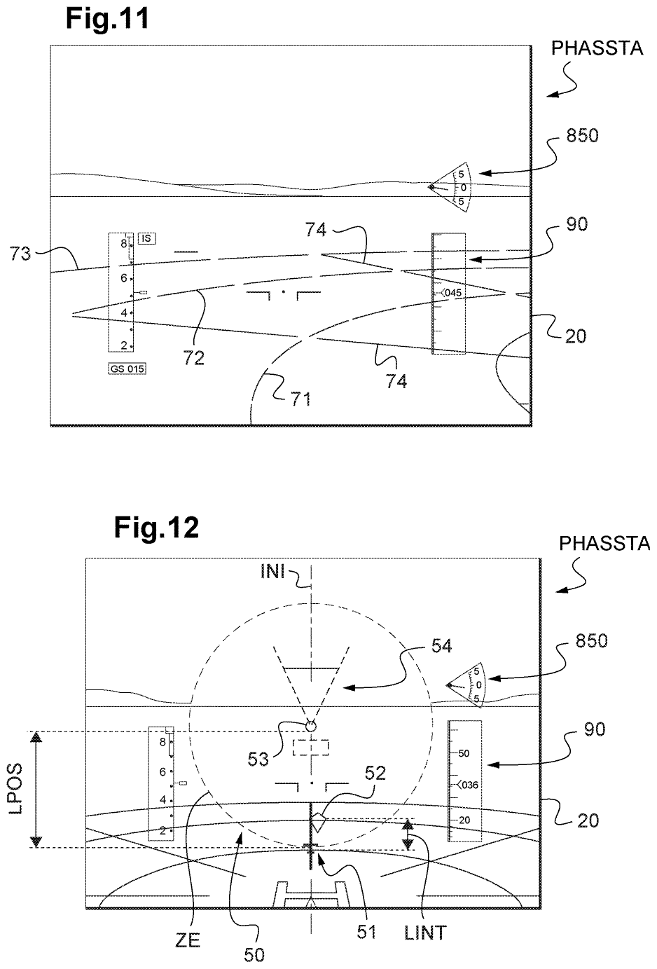

According to the example of FIG. 12, the representation 50 may be contained in a circle ZE of the display 20 rendered partially opaque or semi-transparent. The color of the elements situated under the representation 50 can then be attenuated. This circle ZE of the display 20 can be disposed on and at least partially above the displayed part of the virtual main landing area 40, or of the optional virtual complementary landing area 400. The south/north axis of the circle ZE may correspond to a reference direction INI. The reference direction INI may correspond to the initial alignment direction of the gradient 85. The reference direction INI may be reset by a pilot using a human-machine interface.

Said representation 50 comprises various symbols for which their positions on the display 20, or even their shapes, are determined by the on-board computer 2. These symbols comprise an aircraft symbol 51 representing said aircraft 1, a target symbol 53 representing the touchdown point 101 and possibly of variable size, a displacement symbol 52 representing the displacement of the aircraft 1 relative to the touchdown point 101 as well as an elevation symbol 54 illustrating the height of the aircraft 1 relative to the touchdown point 101.

By default, the target symbol 53 or the aircraft symbol 51 is positioned at a predetermined location, for example at the center of the circle ZE of the display 20.

Optionally, the teaching of patent FR 3 134 176 is applicable for displaying the representation 50.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. A piloting assistance method for landing an aircraft on a target zone centered on a touchdown point,
wherein the method comprises the following steps:
determining using an on-board computer an approach gradient directed towards the target zone;
determining, using the on-board computer, a virtual main landing area positioned, within a representation of the real world, on the target zone, the virtual main landing area comprising at least four main symbols converging towards the touchdown point, the main symbols being oriented radially with respect to the touchdown point, one or two main symbols located in a vertical plane containing the gradient respectively forming one or two alignment symbols, each main symbol not forming an alignment symbol being a radial symbol; and
displaying, on a display, at least one virtual portion of the virtual main landing area, the at least one alignment symbol being displayed in accordance with a first graphic charter, each radial symbol being displayed in accordance with a second graphic charter that is different from the first graphic charter.

2. The method according to claim 1,
wherein the displaying is carried out as long as the aircraft is located at a horizontal distance from the touchdown point less than a transition threshold.

3. The method according to claim 1,
wherein the at least one alignment symbol has, according to the first graphic charter, a first thickness, each radial symbol having, according to the second graphic charter, a second thickness different from the first thickness.

4. The method according to claim 3,
wherein the first thickness is greater than the second thickness.

5. The method according to claim 3,
wherein the first thickness is equal to three times the second thickness.

6. The method according to claim 1,
wherein the at least one alignment symbol has, according to the first graphic charter, a first line style, each radial symbol having, according to the second graphic charter, a second line style different from the first line style.

7. The method according to claim 6,
wherein the first line style and the second line style are chosen from a list comprising: a continuous line, a broken line, dotted lines.

8. The method according to claim 1,
wherein the at least one alignment symbol has, according to the first graphic charter, a first color, each radial symbol having, according to the second graphic charter, a second color different from the first color.

9. The method according to claim 1,
wherein the method includes determining the wind direction, the gradient being disposed facing the wind.

10. The method according to claim 1,
wherein the method comprises determining at least one hazard using at least one terrain database or an obstacle detection system, the gradient being disposed to avoid the hazard.

11. The method according to claim 1,
wherein the gradient is directed towards the touchdown point.

12. The method according to claim 1,
wherein the gradient is directed towards a point located above the touchdown point.

13. An aircraft provided with a display and an on-board computer,
wherein the display and the on-board computer are configured to apply the method according to claim 1, the on-board computer being configured to determine the gradient and the virtual main landing area and the display being configured to display the at least one virtual portion.
